(19) United States
(12) Patent Application Publication
(10) Pub. No.: US 2008/0010633 A1
(43) Pub. Date: Jan. 10, 2008

(54) Knowledge representation language and knowledge processing environment

(76) Inventors: Gordon S. Streeter, Madison, AL (US); Andrew N. Potter, Huntsville, AL (US)

Correspondence Address: LANIER FORD SHAVER & PAYNE P.C., P O BOX 2087, HUNTSVILLE, AL, 35804-2087, US

(21) Appl. No.: 11/888,828

(22) Filed: Aug. 2, 2007

Related U.S. Application Data
(63) Continuation of application No. 11/127,366, filed on May 11, 2005.
(60) Provisional application No. 60/570,242, filed on May 12, 2004.

(51) Int. Cl. G06F 9/45

(52) U.S. Cl. 717/144

(57) ABSTRACT

Described is a knowledge representation language and knowledge processing environment. Embodiments described include an environment for storing, retrieving, transmitting, and reasoning over knowledge. Knowledge is represented using three basic elements: (1) there are concepts, which represent objects or ideas; (2) there are relations, which represent structures and describe the roles concepts play in relation to each other within those structures; and (3) there are graphs, which represent situations or collections composed of concepts, relations, and graphs.

### CROSS REFERENCE TO RELATED APPLICATION

This application claims priority to co-pending U.S. Provisional Patent Application number 60/570,242, filed on May 12, 2004, entitled “KNAML: A Knowledge Representation Language for Distributed Reasoning,” and assigned to the same assignee as this application.

### BACKGROUND OF THE INVENTION

1. Field of the Invention

The present invention generally relates to knowledge management. More particularly, the invention relates to a knowledge representation language and knowledge processing environment.

2. Description of the Related Art

The area of knowledge management is exploding in today's digital age. It seems that anyone, anywhere, at any particular time has instant access to an overwhelming amount of information or knowledge. The Internet has empowered individuals with a new ability to search for information on practically any subject under the sun. Unfortunately, this new ability has also brought to light the horrible inadequacies of existing technology to actually find that information or knowledge even though it may exist somewhere. The problem is that there aren't any truly effective mechanisms for assembling and making all that knowledge easily accessible. For example, an analogy to a digital information search is a person searching his own mind for the answer to a question. The human brain has an amazing capacity to not only retain knowledge, but to organize and process it. It seems today that computing technologies have probably exceeded the human mind's ability for knowledge storage capacity, but pale in comparison to the human mind's ability to organize and process that stored knowledge.

Information providers and those interested in making their knowledge more accessible struggle with developing ways to not only store knowledge, but to represent the knowledge in some fashion that allows it to be more efficiently organized and processed. In other words, it is not enough to simply store countless disparate and disconnected bits of information, it must also be organized in a fashion that allows the information to be retrieved. All the information in the world is useless unless it can be effectively processed and retrieved when needed.

Thus, an adequate knowledge representation language and knowledge processing environment have eluded those skilled in the art, until now.

### SUMMARY OF THE INVENTION

Briefly stated, the invention is directed at a knowledge representation language and knowledge processing environment. In one aspect, the invention provides a computer-readable medium encoded with a knowledge data structure. The data structure includes three elements, a concept that represents an object or idea; a relation that represents at least one structure and describes a role that the concept plays in relation to other concepts within the structure; and a graph that represents a collection of concepts, relations, and other graphs.

In another aspect, the invention provides a method and computer-executable instructions for representing knowledge as a data structure. The method and instructions include assigning certain information to a concept; representing a role that the concept plays in relation to other concepts using a relation; and representing the concepts and the relation using a graph.

These and other aspects and features of the invention will become more fully apparent from the following description and appended claims, and may be learned by the practice of embodiments of the invention as set forth below.

### BRIEF DESCRIPTION OF THE DRAWINGS

With reference to the figures in which like numerals represent like elements throughout

FIG. 1 is a conceptual diagram of knowledge represented using the graphical form in accordance with an embodiment of the invention.

FIGS. 2-3 are conceptual diagrams of knowledge represented using the linear form in accordance with an embodiment of the invention.

FIG. 4 is a conceptual diagram of knowledge represented using the eXtensible Markup Language (“XML”) form in accordance with an embodiment of the invention.

FIGS. 5-12 are conceptual diagrams of knowledge represented using the linear form and illustrating various techniques of an embodiment of the invention.

FIG. 13 is a functional block diagram generally illustrating the core components of a sample computing device in which implementations of the invention may be embodied.

### DETAILED DESCRIPTION OF THE INVENTION

What follows is a detailed description of various mechanisms and techniques for knowledge representation and manipulation. Described is one implementation of a knowledge representation language and knowledge processing environment. The techniques described here may be implemented using any multi-agent knowledge-based system, such as, for example the KnoWeb® knowledge based system owned and licensed by the assignee of this application and which is the subject of U.S. Pat. No. 6,763,342.

System Overview

The invention will be described with reference to one particular implementation of the inventive concepts. That specific implementation is termed “KNAML”, and will be referred to throughout this document. Although described here with specific reference to KNAML, the invention is not limited to this specific implementation and can be implemented in other ways.

In one aspect, KNAML is a knowledge representation language. However, more than a language, KNAML is an environment for storing, retrieving, transmitting, and reasoning over knowledge. Knowledge is represented in KNAML using the following three basic elements: (1) there are concepts, which represent objects or ideas; (2) there are relations, which represent structures and describe the roles concepts play in relation to each other within those structures; and (3) there are graphs, which represent situations or collections composed of concepts, relations, and graphs.

Knowledge Representation in KNAML

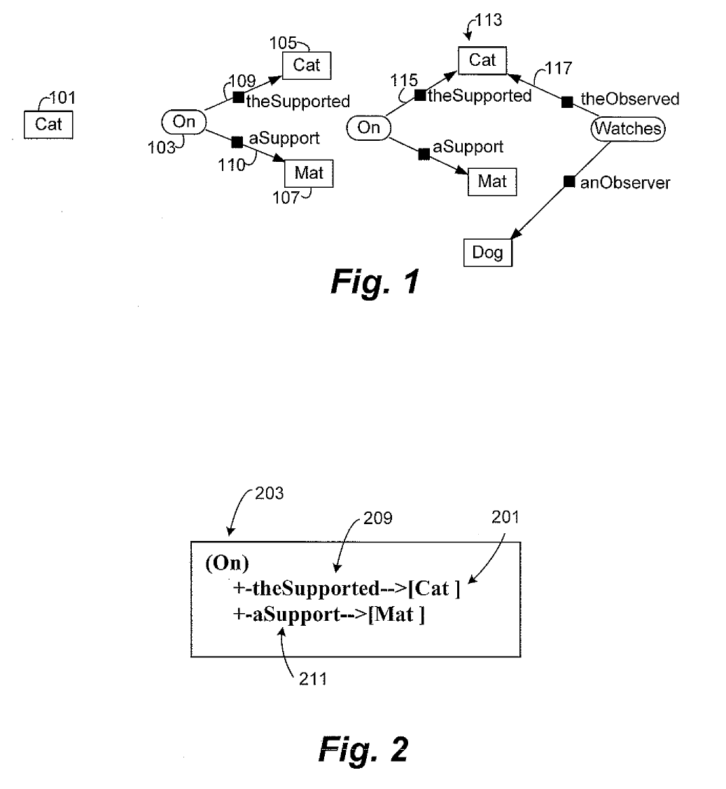

KNAML representation takes many forms: graphic, linear, XML, and programmatic. FIG. 1 shows all three elements in graphical form. On the left is a simple concept 101, shown as a rectangle. The concept 101 depicts a cat. In the middle is a relation 103. The relation 103 is shown as a bubble containing the relation type with arcs drawn from the relation 103 to the related concepts (105, 107). The arcs (109, 111) have unique labels that describe the roles the concepts play in the relation. On the right in the figure is a graph 113. Technically, all three images in FIG. 1 are graphs; the rightmost is just slightly more complex. In fact, graphs do not have to be connected, so the three images together could also be considered a single graph.

KNAML assumes existential conjunction. This means that existential quantification prevails, and all statements are tacitly joined by conjunction. So, the statement made by the rightmost graph 113 in FIG. 1 can be read as follows: “There exists a mat, a cat, and a dog, such that the cat is on the mat and the dog watches the cat.” The assumption of existential conjunction allows KNAML to be used for logical statements even though it contains no explicit logical operators.

Referring now to FIG. 2, the linear form of KNAML is a rough approximation of the graphical form that can be achieved typographically. Concepts are represented in square brackets, such as “[Cat]” 201. The relation 203 is depicted with parentheses, and the arcs with a series of characters (209, 211).

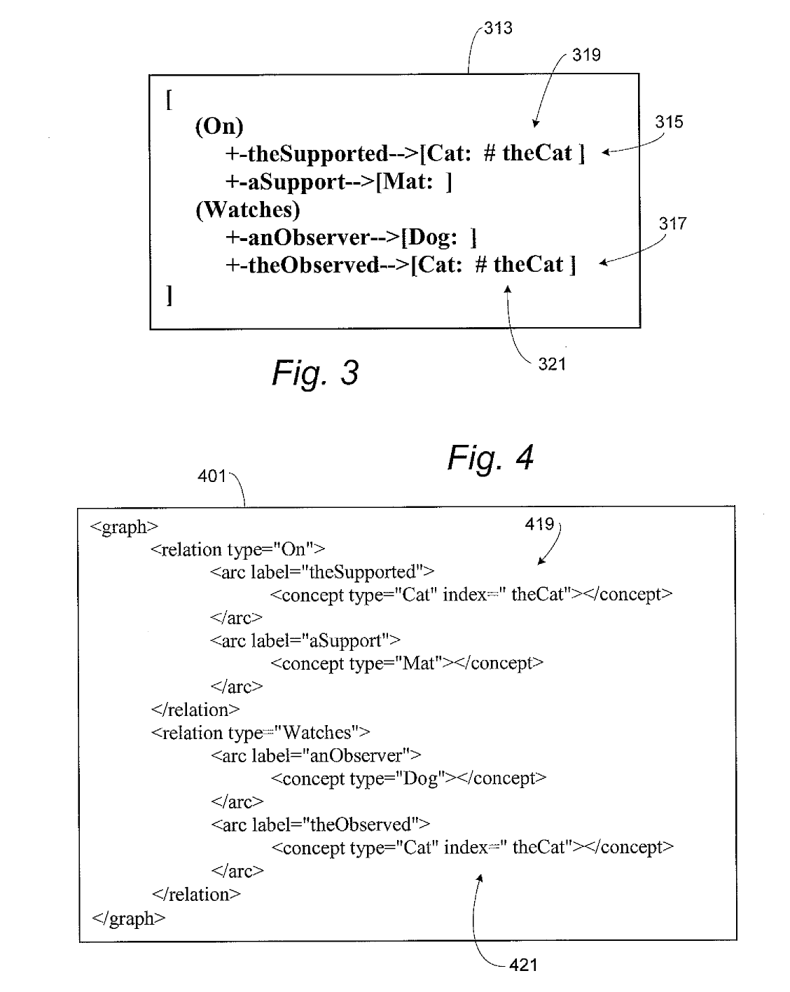

In the linear form, a graph is also delimited with square brackets, and in some cases graphs can be somewhat similar to concepts. Empty graphs, for example, look remarkably similar to trivial concepts. Referring now to FIG. 3, nonempty graphs begin with a left bracket followed by the first element of the graph indented on the next line. Successive elements are emitted on following lines at the same indentation, and the graph is closed with a right bracket. This description is depicted in the graph 313 shown in FIG. 3, where the rightmost graph 113 from FIG. 1 is shown in linear form.

Note that, since the arcs in the linear form always point forward, there is no way for both relations to have arcs to the same representation of the cat concept. Instead, two concepts (315, 317) are labeled with the same index or “indexical” (319, 321) to indicate that they represent the same concept. Indexes are also used in the programmatic form as an identifier to locate and retrieve concepts nested in within a knowledge module or other conceptual structure.

Given the preceding discussion, the XML representation is a fairly straightforward representation of the elements of KNAML already described, as can be inferred from FIG. 4. As seen in FIG. 4, an XML representation 401 of the graph 113 from FIG. 1 is constructed using tags that generally correspond to each of the three basic KNAML elements. While the graphic and linear forms are for human interpretation, the XML representation is for interpretation by computer programs: chiefly agents and knowledge building tools. The XML form of KNAML is used in agent messages, knowledge modules, agent configuration files, etc.

The KNAML elements may also be represented programmatically, such as with Java classes or the like. The programmatic representation closely follows the XML elements shown in FIG. 4, except that there are also various methods which perform operations on the KNAML structures. The major methods will be discussed in more depth below, but among them are methods to emit the dynamic, programmatic representation to XML, and to parse static XML into the programmatic representation. As there is a great deal of structural similarity between the two representations, the conversion back and forth between elements is fairly straightforward.

Elements of KNAML

As previously stated, the basic elements of KNAML are the three types of conceptual structures known as “concepts”, “conceptual relations” (or simply “relations”) and “conceptual graphs” (or, again “graphs”). A relation always has a type. The type is defined in the context of a particular ontology, and this ontology describes the relation type, indicating the number of arcs, the label of each arc, and optionally the type of the concept at the end of the arc. The makeup of a graph is fairly simple: it contains some number of concepts, graphs, and relations. The slight twist is that the number may be unspecified, that is, it may be unknown or immaterial.

The possibilities for a concept are much more complex. To begin with, as has already been mentioned, there is the trivial concept, “[ ]” which may be read as “something”. Also already mentioned are concepts composed only of a type specifier, as in “[Cat]” and “[Place]” which may be read as “a cat” and “a place”, respectively. The remaining simple form of concept is called the primitive form, as it holds a single primitive value. The only primitive type supported by this implementation of KNAML is the string, though other types may be encoded as strings. Primitives are represented by strings in quotes, such as ‘[“Bob”]’. Primitives may be combined with type specifiers to show that the primitive value is of a particular type. For example, ‘[Person: “Bob”]’ and ‘[Cat: “Felix”]’ are read as “the person ‘Bob’” and “the cat ‘Felix’”, respectively. Note that the technically accurate reading is, for example, “the person with the value ‘Bob’”. However, this is no different than noting that, in a conventional programming language, “1” is not the number one, but rather a number with the value one.

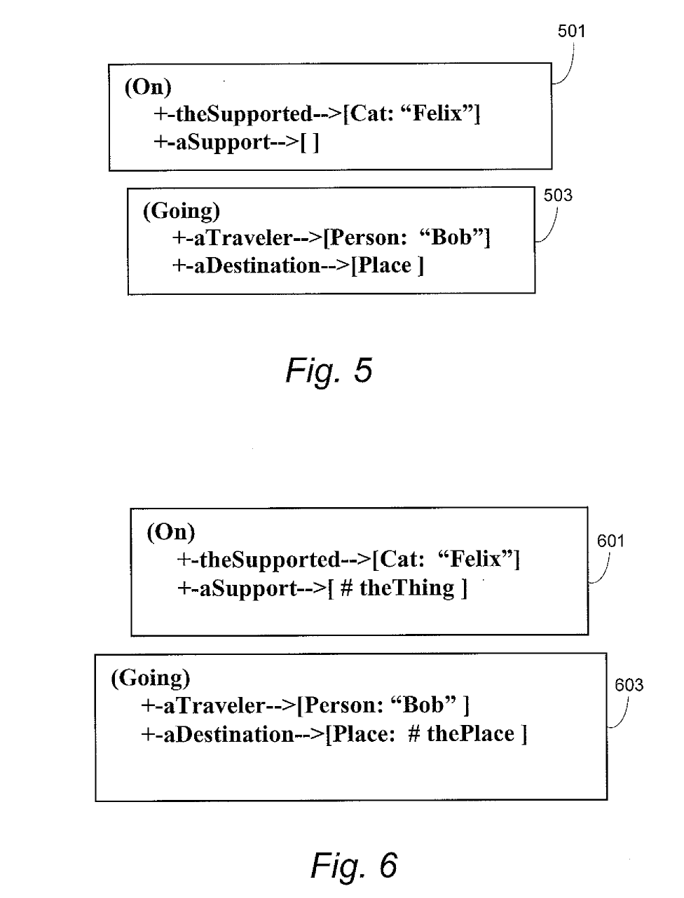

Referring now to FIG. 5, two statements provide examples of these simple conceptual forms. The first statement 501 may be read as “the cat, ‘Felix’, is on something”, and the second statement 503 may be read as “the person, ‘Bob’, is going someplace”. These statements are valid, though they are vague, but the value of such an expression is most often as a goal, rather than a statement. FIG. 6 shows equivalent expressions (601, 603 respectively) which are intended to be used as goals. As goals, they may be read “what thing is the cat, ‘Felix’ on?” (statement 601) and “to what place is Bob going?” (statement 603). The indexes (“theThing” and “thePlace”) have been added because KNAML provides support for finding concepts by index, so important concepts are labeled in such expressions so that they may be easily retrieved.

One of the more complex forms of the concept is called the plural form. For example, the color red may be represented as a concept by ‘[Color: “Red”]’, while the colors red, green, and blue (collectively) may be represented as:
[Color: {“Red”, “Green”, “Blue”}]

As with graphs, the content of a plural may be unspecified, and so ‘[Color: {*}]’ may be read as “some colors”. Plural concepts are similar to graphs in that they are collections. Unlike graphs, however, plural concepts may contain only concepts. Further, if the parent concept has a type specifier, the child concepts should have the same type as the parent.

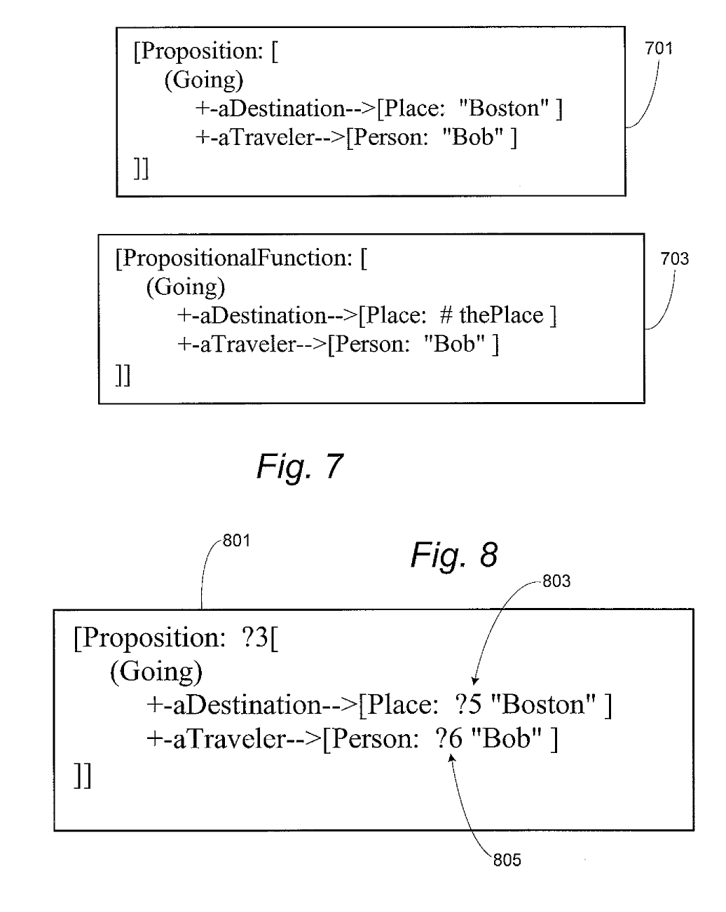

Alternatively, a concept may contain a graph. Two commonly used concept types which may contain an arbitrary graph are Proposition, for which the graph represents a statement, and PropositionalFunction, for which the graph represents a goal. For example, shown in FIG. 7 is a proposition concept 701 that may be read as the statement “Bob is going to Boston”. Also shown in FIG. 7 is a propositional function concept 703 that may be read as the query “Where is Bob going?” Note that the order of arcs is different in FIG. 7 than in the previous figures. In KNAML in general, order is not significant, such as in the order of arcs, the order of concepts in plurals, the order of elements in a graph, etc.

Modules

A “module” is a specialized KNAML concept. Viewed statically, the module is a concept containing a graph which contains a single relation. The relation in a module links concepts with the following four roles.
(1) There is a context, which is the subject matter of the module. Other concepts in the relation contain meta-knowledge.
(2) There is an ontologies concept, which is a plural concept whose members list all the ontologies referred to in the context.
(3) There is a catalog, which is a concept containing a graph. The graph is used as a collection and contains a single reference to every unique structure in the context.
(4) There is a counter, which is a primitive concept. This primitive contains an encoded integer, which is used to provide a unique identifier for structures as they are added to the catalog.

Dynamically, the module provides methods to add and remove items from the catalog, and to maintain the integrity of the relationship among the four members of the relation. The dynamic implementation of the module also maintains a collection of any indexes used in the context, and the concepts by which those indexes are used, so that the same index can not be used for different concepts.

The purpose of a module is to provide a closure within which individual conceptual structures can be referred to and identified either by the unique identifier assigned by the module, or, in the case of concepts, possibly by an index. The unique identifier is known as an individual marker, or simply a marker. In the current implementation, markers are shown in linear form as an integer following a question mark. For example, as shown in FIG. 8, the marker “?3” identifies the proposition concept, the marker “?5” identifies the place concept 803, and the marker “?6” identifies the person concept 805.

Modules provide the basic functionality for knowledge modules, but the closure provided by modules is also fundamental to the proper storage and retrieval, or transmission and reception, of knowledge.

Consider the graphs shown in FIG. 1, FIG. 3, and FIG. 4, where the retrograde arcs (115, 117) in the first graph 113 have been implemented with indexes in the latter two (319, 321 in FIG. 3; 419, 421 in FIG. 4). With an understanding of indexes, it makes visual sense that the two concepts with the index “theCat” are the same concept. To a parser, however, if the concepts were parsed outside the scope of a module, they would be parsed as two concepts with the same index. However, within the scope of a module, whenever a new concept is parsed that has an index (or a marker) the module consults the catalog to see if the indicated concept already exists in the catalog and, if so, whether the existing definition is consistent with the new definition. If both conditions are true, the module binds the two concepts and returns the bound concept to the parser for further processing. Without such processing, the act of emitting and reparsing even moderately complex graphs would cause a loss of fidelity in the structure of the graphs.

Frames

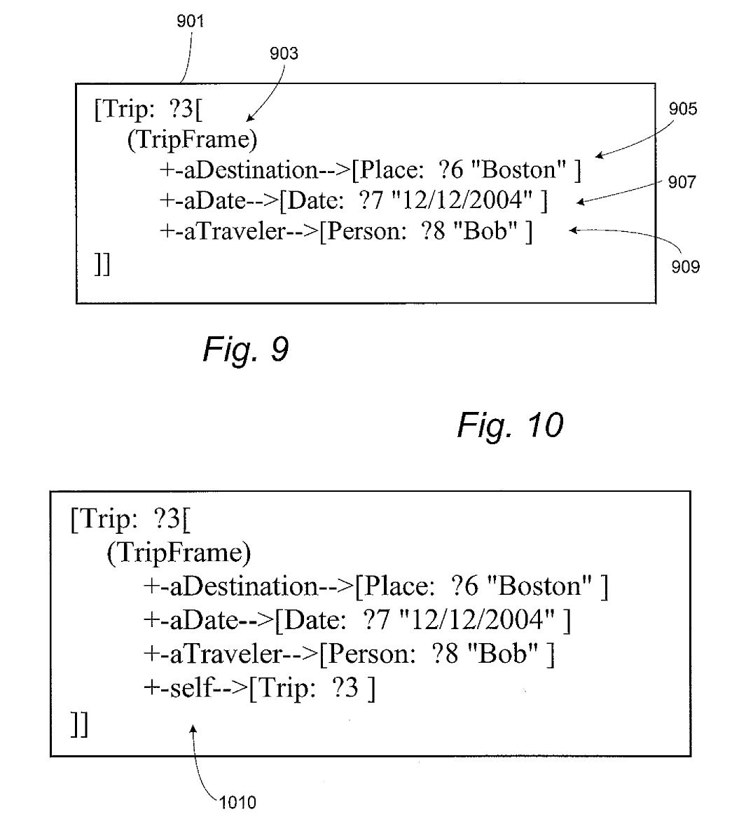

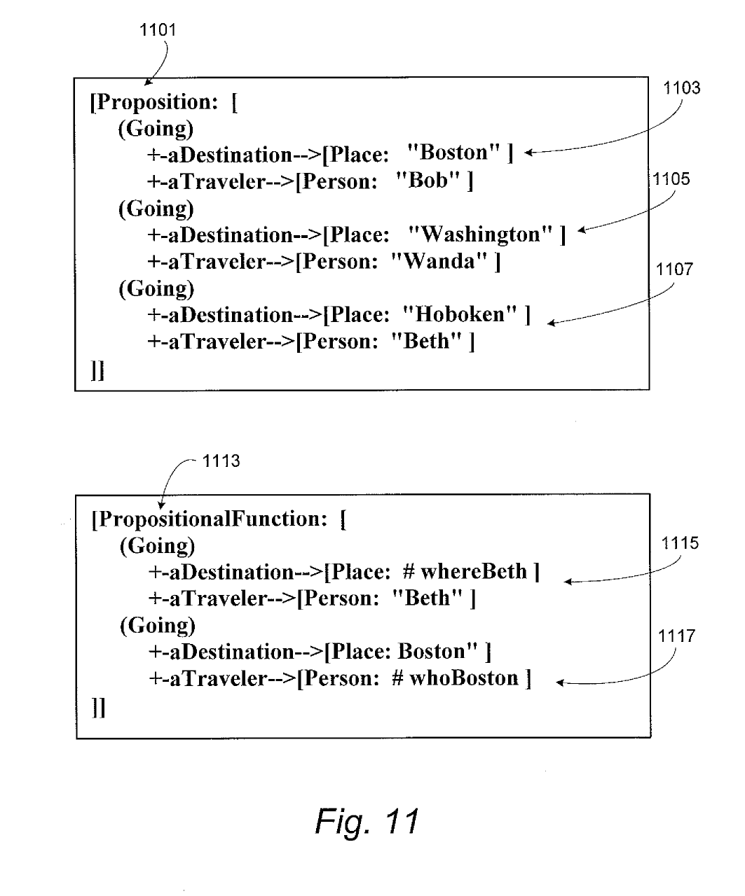

The module is an example of a class of complex concept called a framed concept, or more simply, a frame. A framed concept is composed of a concept containing a graph which contains a single relation. The relation, called the frame relation, provides the structure for the content of the framed concept. An example of a framed concept is shown in FIG. 9, where the frame “Trip” 901 contains the frame relation “TripFrame” 903, which defines the relationships between the concepts “Place” 905, “Date” 907, and “Person” 909.

Framed concepts have several beneficial aspects. Pragmatically, they provide structure for the content of a concept. This structure, of course, is available from a relation, without the overhead of a concept Recall, however, that graphs are inherently bipartite, with relation nodes and concept nodes, and that arcs are always from relations to concepts. Also, only concepts can have names, relations cannot. So, we may state that “Bob is going to Boston” within the context of a proposition, ask “is Bob is going to Boston?” within the context of a propositional function, or otherwise manipulate the relation in the context of a graph, or a graph within a concept, but we cannot directly manipulate or identify the relation. This is not a limitation of the implementation, but rather is based on the theory behind the distinction between relations and concepts.

For example, if Bob is a frequent traveler, and is going not only to Boston, but also to Chicago, then these separate facts could be recorded in separate propositional functions. Then, we could ask “is Bob going to Boston” or “is Bob going to Chicago” and get an affirmative answer. However, if we were to ask “where is Bob going”, we would need to be prepared for multiple answers. This may be achieved with “Going” relations in the context of propositions. If, however, we begin to deal with the relations individually, or compare them to each other (perhaps wondering about their order of occurrence) then we have conceptualized the two separate relations. We are no longer treating it as an idea that relates concepts, but as a concept itself. As suggested in FIG. 9, the idea of “Going” has become the concept of “Trip”. Programmatically and conceptually, frames combine the attributes of concepts and relations. Specifically, frames have both the structural nature of relations and the referential quality of concepts.

Frames also provide for a simple, powerful means of ontological specification. Specification of relations does not pose any particular problems, involving only the following components: (1) the name of the relation type; (2) the labels for the arcs; (3) optionally for each arc, the type of the concept to which the arc is restricted; and (4) optionally for each arc, an indicator that the concept is a plural concept.

Without frames, concept types are difficult to specify, as the interior of a concept graph may have any form. With frames, the form of the content is specified by the frame relation. In the simplified ontological specification, then, the concept is specified in two parts: the name of the concept type and, optionally, the name of the relation type for the relation frame, if the concept is a framed concept. Non-framed concepts might also be further specified as primitive, enumerated, or open graphs (such as propositions).

The result of this approach is a simple, powerful means of ontological specification in which not only the ontology, but the ontological specification (the “ontology ontology”) may be expressed in KNAML.

A final, theoretical note on frames is worth consideration. While it is obvious from context that the frame relation of a concept belongs with the concept, the context may not always be as easily discernable as it is in the visual presentation. Visually, one can navigate from the concept to the graph to the relation frame, and the theory agrees: the concept does contain a graph which contains the relation. Visually, one can also navigate the reverse direction, but the theory is of no help here—there is no theoretical linkage from the relation to the graph or from the graph to the concept. In other words, one cannot rely on an element having a reference to its parent as this is (a) not theoretically sound, and (b) not reliable because it assumes a single parent, which may not be true, and the reference is always overwritten by the latest parent of the element. Thus, in theory, each frame relation has an arc which relates back to the enclosing concept. By convention, this is called a “self” arc 1010, and is illustrated in FIG. 10.

The self arc 1010 not only provides a path from the frame relation back to the framed concept, but more accurately portrays the fact that the relation relates all the “slots” not only to each other, but also to the framed concept. The self arc 1010 may be omitted because the programs dealing with the frames need neither the theoretical nor practical benefits it provides.

Knowledge Processing in KNAML

The linear and graphic forms of KNAML are useful in representing knowledge in a way that is understandable by humans. The XML form of KNAML is machine-readable, but like the linear and graphic forms, it is static, representing a snapshot of knowledge as a knowledge module is saved to a file, a message is sent from one agent to another, etc. The programmatic form of KNAML not only represents knowledge, it provides for dynamic operations on that knowledge. What follows here is a discussion of those dynamic operations enabled by the programmatic form.

Among the primary operations KNAML provides are the creation and editing of conceptual structures, graphs being the simplest structures. Structures may be added to or removed from a graph at any time. A graph may also be set to an “unspecified” state, which means the number of and identity of the structures associated with the graph is unknown or undetermined. If the graph is set to this state, any structures associated with the graph are released. If a structure is added to the graph when the graph is in the unspecified state, the unspecified state is cleared.

Basically, a concept is defined by setting the concept type and the content type. The concept type is a string, selected from the ontology in use. The content type is either “empty”, meaning the concept has no content, “primitive”, meaning the concept contains a primitive value, “plural”, meaning the concept represents a plural value, or “context”, meaning the concept contains a graph. The content type of a concept may be changed from empty to any of the other types, or from any of the other types to empty. In the latter case, any value associated with the concept is released. Depending on the content type, the concept provides access to the primitive value, the plural, or the graph. At any time, the concept provides for access to the various locators.

Relations are created by providing the relation type, and then adding the required arcs. Arcs are created with a label and a concept. As the relation is being created, there is a period of time before all the arcs have been added when the relation is not ontologically correct. This state is allowed because, for example, when a relation is being created in a graphical editor, it will necessarily be incorrect until editing is complete. Relations provide functionality to add and remove arcs and retrieve and set concepts by arc label.

Except in the case of abstract utilities such as editors and parsers, relations, in particular, are most often not created by means of the low-level Relation class. Instead, concepts and relations are often created and manipulated by means of domain specific ontology classes. These classes generally provide convenience functions for the creation of relations and framed concepts from their constituent concepts as well as other convenience accessor functions, but may also provide domain specific operations such as validation, state processing, etc.

Code that is reliant on such domain specific ontologies should make special provisions if the structures are stored or transmitted and reparsed, copied, etc. as the default behavior is to generate generic concepts and relations. This behavior can be controlled by use of a factory. A factory is used to generate concepts and relations, and factories can be configured and provided to the parser, etc. such that domain specific ontology classes will be created as appropriate.

Subsumption

The notion of subsumption is fundamental to knowledge processing in KNAML in that it provides for the basic comparison of structures. Speaking informally, one structure subsumes another if the first is similar in structure to the second and no more specific in detail. The importance of subsumption is in its application to inference: if a structure p subsumes the structure q, then p can be inferred from q.

For example, in FIG. 7 the graph in the propositional function (703) is of the same form as the graph in the proposition (701), but is more general. Therefore, the graph from the propositional function (703) subsumes the graph in the proposition (701). In more common terms, if Bob is going to Boston, it can be inferred that someone is going to Boston.

The notion of subsumption is used extensively in KNAML. It is used to match a particular requirement with a more general agent capability, to test a goal against known context, etc. The precise definition of the subsumption is critical. A conceptual structure p is said to subsume the structure q if the following conditions hold:
1. If p and q are concepts, then p subsumes q if the type of p subsumes the type of q and the content of p subsumes the content of q.
   a. The type of p subsumes the type of q if the former is unspecified or if the two are identical.
   b. The content of p subsumes the content of q if any of the following are true:
      i. The content of p is empty.
      ii. The contents of p and q are primitive of p subsumes the primitive of q. The primitive of p subsumes the primitive of q if the value of p is empty or if the two values are identical.
      iii. The content of p and q are plurals and the plural of p subsumes the plural of q.
      iv. The content of p and q are graphs and the graph of p subsumes the graph of q.
2. If p and q are relations, then p subsumes q if the type of p is identical to the type of q and the arcs of p subsume the arcs of q. The arcs of p subsume the arcs of q if all of the following are true.
   a. The number of arcs in p is equal to the number of arcs is q.
   b. There is a one-to-one match from the arc labels in p to the arc labels in q.
   c. The concept at the end of each arc with a given label in p subsumes the concept at the end of the arc with the same label in q.
3. If p and q are graphs, then p subsumes q if any of the following conditions hold.
   a. The content of p is unspecified.
   b. Both p and q are empty.
   c. p is non-empty, and for every structure in p, there is a unique correspondence to a structure in q which is subsumed by the structure in p.

Unification

Unification is an extension of subsumption which supports discovery by showing how one structure is subsumed by another. Unification takes two arguments, the unifier and the unificand, which correspond to p and q, above, and if successful produces a unified result. Briefly, unification processing is as follows. The unifier and unificand are recursively descended according to the subsumption check above. As subsumption succeeds, the result is constructed. If any subsumption check fails, unification backtracks to the last choice point. Choice points are created at non-empty graphs and plurals; when one correspondence between an element from the unifier and the unificand fails, another is attempted.

The unified result is created by copying the unifier except in the following cases:
1. If the unifier is a concept and the type is not specified, the result has the type of the unificand.
2. If the unifier is an empty concept and the unificand is nonempty, the content of the result is copied from the unificand.
3. If the unifier is an unspecified plural concept, and the unificand is a specified plural, the result is copied from the unificand.
4. If the unifier is a primitive concept with no value, the result has the value of the unificand.
5. If the unifier is an unspecified graph and the unificand is a specified graph, the result is copied from the unificand.

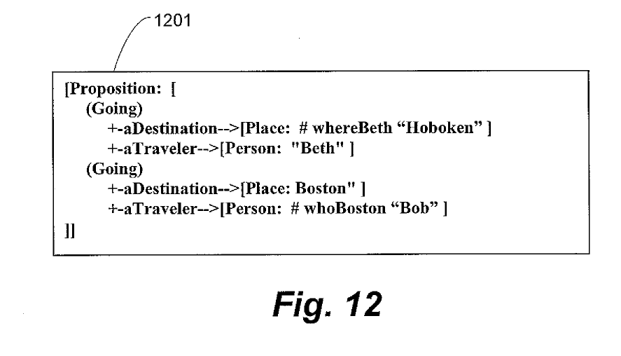

FIG. 1 shows a proposition 1101 with a graph representing known going relations: Bob is going to Boston (1103), Wanda is going to Washington (1105), and Beth is going to Hoboken (1107). The graph in the propositional function (1113) is for the question “who is going to Boston?” (1115) and “where is Beth going?” (1117) The result of the unification of the graphs is shown in the proposition 1201 in FIG. 12. Note that it has the form of the unifier (i.e., proposition 1101), but the detail of the unificand (i.e., propositional function 1113). Note also that the indexes from the unifier are copied to the unificand. This is to allow interesting concepts in the unifier to be labeled and then easily located in the result.

Binding

The bind operator takes two arguments, a receiver and a binding, which correspond to the unifier and the unificand. The binding process is conceptually similar to unification, but where unification leaves the arguments unchanged and produces the result in a separate structure, binding is a modifying process (when successful) which produces the result in the receiver. In the cases listed above for unification where the result would be copied from the unificand, in the binding operation the same values are bound from the binding argument to the receiver. For instance, if the receiver were an unspecified graph and the binding were a graph with two members, the two members would be added to the receiver. As a result, the original members of the binding would become members of both graphs.

Binding is currently used in KNAML in two ways. The parser uses binding to resolve concept references with full concept definitions. When the emitter emits a concept, it emits the full concept only once and thereafter emits only a reference (the concept type, if there is any, and any locators). This is not only more efficient than emitting the entire concept on each occurrence, but provides a recursion check for self-referential and other recursively-linked structures. When the emitted KNAML is reparsed, the parser reconnects these separate references to the same concept. It has already been mentioned that the module provides the context for this operation, but binding is the method by which they are reconnected. When the parser, in the scope of a module, encounters a concept with a locator it has already encountered, it binds the two concepts. So, whether it had previously encountered the reference and has come upon the full definition, or vice-versa, the result is that each becomes the full definition. Note that unification would not be useful in this case, as it would leave the two concepts unchanged and produce a third, unconnected to the two and or to their respective contexts.

Binding may also be used by other agents, such as a workflow agent, to establish context for the knowledge module. When the knowledge module is initially programmed in a knowledge editor, the capability of the module is defined as a part of the module. For example, workflow capabilities involve events, and these events are defined as a part of a workflow capability. Within the logic of the workflow, the goals and guards (conditional elements of the workflow) refer by index to concepts defined in the capability. When the workflow is invoked, the workflow agent makes a copy of the workflow for each event and binds the event with the capability, thus each reference to concepts in the capability becomes bound, as well, to specific elements of the event.

Pattern Unification

Pattern unification is a derivative of unification used specifically for pattern matching. Unlike unification, it has no logical meaning. In the described implementation, pattern matching is used almost exclusively as a part of the process of translating KNAML to external XML.

Briefly put, whereas unification is controlled by the form of the unifier, pattern unification provides a means whereby the result may have the form of the unificand. The only difference between the process of unification and pattern unification is this: in pattern unification, when the unifier is a plural with a single member and the unificand is a plural with zero or more members, the unifier is temporarily adjusted to be the same size as the unificand. If the unificand is empty, then the unifier is made empty; if the unificand has more than one element, then the single element of the unifier is replicated as many times as necessary to achieve the required size. The result is that the same plural unifier will match the unificand whether it has zero or non zero elements, which would not be the case in unification, and the replicated element in the unifier will be matched against every element in the unificand, where unification would only require a single match for the single element.

Knowledge Modalities

In a multi-agent system, agent specializations may occur along lines of knowledge domains. For example, one agent might specialize in some area of product diagnostics, and another could specialize in customer service. The two agents combined would be useful in creating a product support application. However, there is another form of specialization, one which occurs along lines of knowledge modalities. That is to say, the agents specialize in their forms of knowledge representation. Some problems are best solved by using rules, others by using decision trees, and still others respond well to workflows. The possibilities are presumably unlimited. Consequently, a single form of knowledge representation, no matter how powerful, is insufficient. Using the wrong representation leads to poor design, difficult knowledge authoring, and poor system performance.

KNAML supports an extensible set of modalities, such as workflows, rules, decision trees, and graphs. This is accomplished by using KNAML ontological support to create ontologies for specialized modalities. Each modality is accompanied by a corresponding editor that enables the user to create integrated knowledge projects, consisting of a set of multi-modal knowledge modules defined to address a predefined range of problems using a multi-agent architecture.

For example, the workflow modality allows knowledge to be authored, expressed, and processed as workflows, using workflow symbology. The workflow agent implements UML activity diagrams, including actions, forks, merges, branches, joins, and transitions. Workflow activities and transition guards include goals, which are expressed as KNAML graphs. At runtime, these goals are evaluated and the results are used to determine the path taken by the workflow. That multi-agent systems would benefit from a well-defined agent interaction protocol is clear. The workflow agent orchestrates the behavior of the multi-agent system, and it does so in an architecturally neutral manner. A workflow is a tactical plan for solving a problem. By specifying the steps required to solve the problem, the order in which they are to be taken, and the conditions under which they will be invoked, the workflow provides a coherent approach to agent cooperation. Because activities performed by other agents (possibly including other workflow agents) are mediated through a meta agent, workflows can maintain goal-level visibility into the problem solving process. This simplifies the knowledge representations required by individual agents and reduces the need for extensive pre-conditions on agent capabilities. Supporting the workflow agent is a workflow editor used to create workflow modules.

Thus, in addition to support knowledge processing, the multi-modal approach makes knowledge representations more intuitive for non-logicians. This is a significant benefit, especially in contrast to knowledge representations which rely exclusively on description logics, markup languages, or some combination of the two.

Illustrative Computing Environment

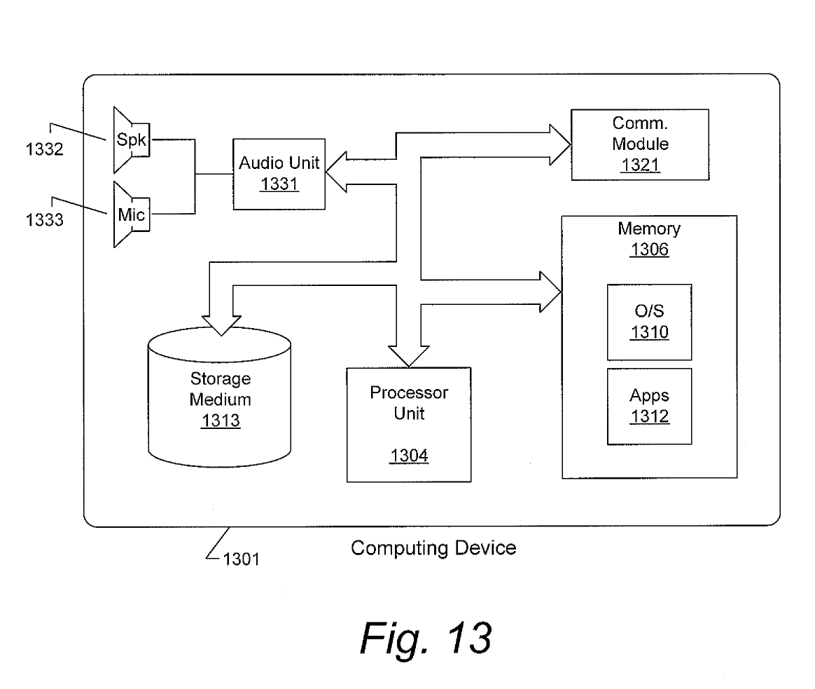

FIG. 13 is a functional block diagram generally illustrating the core components of a sample computing device 1301 in which implementations of the invention may be embodied. The computing device 1301 could be any computing device, such as a laptop computer, a desktop computer or workstation, or a server.

In this example, the computing device 1301 includes a processor unit 1304, a memory 1306, a storage medium 1313, and an audio unit 1331. The processor unit 1304 advantageously includes a microprocessor or a special-purpose processor such as a digital signal processor (DSP), but may in the alternative be any conventional form of processor, controller, microcontroller, or state machine.

The processor unit 1304 is coupled to the memory 1306, which is advantageously implemented as RAM memory holding software instructions that are executed by the processor unit 1304. In this embodiment, the software instructions stored in the memory 1306 include an operating system 1310 and one or more other applications 1312. The memory 1306 may be on-board RAM, or the processor unit 1304 and the memory 1306 could collectively reside in an ASIC. In an alternate embodiment, the memory 1306 could be composed of firmware or flash memory.

The processor unit 1304 is coupled to the storage medium 1313, which may be implemented as any nonvolatile memory, such as ROM memory, flash memory, or a magnetic disk drive, just to name a few. The storage medium 1313 could also be implemented as any combination of those or other technologies, such as a magnetic disk drive with cache (RAM) memory, or the like. In this particular embodiment, the storage medium 1313 is used to store data during periods when the computing device 1301 is powered off or without power.

The sample computing device 1301 also includes a communications module 1321 that enables bidirectional communication between the computing device 1301 and one or more other computing devices. The communications module 1321 may include components to enable RF or other wireless communications, such as a Bluetooth connection, wireless local area network, or perhaps a wireless wide area network. Alternatively, the communications module 1321 may include components to enable land-line or hard-wired network communications, such as an Ethernet connection, RJ-11 connection, universal serial bus connection, IEEE 13394 (Firewire) connection, or the like. These are intended as non-exhaustive lists and many other alternatives are possible.

The audio unit 1331 is a component of the computing device 1301 configured to convert signals between analog and digital format. The audio unit 1331 is used by the computing device 1301 to output sound using a speaker 1332 and to receive in put signals from a microphone 1333.

FIG. 13 illustrates only certain components that are generally found in most conventional computing devices. Very many other components are also routinely found in particular implementations, and in certain rare cases, some components shown in FIG. 13 may be omitted. However, the computing device 1301 shown in FIG. 13 is typical of the devices commonly found today.

While the foregoing disclosure shows illustrative embodiments of the invention, it should that various changes and modifications could be made to the described embodiments without departing from the spirit and scope of the invention as defined by the appended claims. Furthermore, although elements of the invention may be described or claimed in the singular, the plural is contemplated unless limitation to the singular is explicitly stated.

1. A computer-readable medium encoded with a knowledge data structure, comprising: a concept that represents an object or idea; a relation that represents at least one structure and describes a role that the concept plays in relation to other concepts within the structure; and a graph that represents a collection of concepts, relations, and other graphs.

2. The computer-readable medium recited in claim 1, wherein the knowledge data structure is represented in a graphical, linear, markup-based, or programmatic form.

3. The computer-readable medium recited in claim 1, wherein the relation has a type, the type is defined in the context of an ontology, and the ontology describes the relation type by indicating a number of arcs for the relation type, a label for each arc, and a type of a concept at the end of each arc.

4. The computer-readable medium recited in claim 1, wherein the graph can be expressed as a logical statement in the existential-conjunctive subset of first order logic.

5. The computer-readable medium recited in claim 1, wherein a selected one of the concept, the relation, or the graph represents a first structure and a different instance of the selected one of the concept, the relation, or the graph represents a second structure, and further wherein the first structure is similar to the second structure and no more specific in detail, and further wherein the first structure subsumes the second structure.

6. The computer-readable medium recited in claim 5, further comprising means for unifying the first structure and the second structure into a third structure if the subsumption succeeds to provide discovery.

7. The computer-readable medium recited in claim 5, further comprising means for binding the first structure into the second structure to provide knowledge synthesis.

8. The computer-readable medium recited in claim 1, wherein the concept comprises a frame containing a graph that contains a single relation, and wherein the frame provides qualities of the concept and the relation.

9. (canceled)

10. (canceled)

11. The computer-readable medium recited in claim 1, wherein ontological support is used to create ontologies for specialized modalities to achieve extensibility.

12. A method for representing knowledge as a data structure encoded on a computer-readable medium, comprising: assigning certain information to a concept; representing a role that the concept plays in relation to other concepts using a relation; and representing the concepts and the relation using a graph.

13. The computer-readable medium recited in claim 12, wherein the concept, the relation, and the graph are represented in a graphical, linear, markup-based, or programmatic form.

14. The method recited in claim 12, wherein the relation has a type, the type is defined in the context of an ontology, and the ontology describes the relation type by indicating a number of arcs for the relation type, a label for each arc, and a type of a concept at the end of each arc.

15. The method recited in claim 12, further comprising using ontological support to create ontologies for specialized modalities to achieve extensibility.

16. The method recited in claim 12, wherein the graph can be expressed as a logical statement in the existential-conjunctive subset of first order logic.

17. The method recited in claim 16, wherein a selected one of the concept, the relation, or the graph represents a first structure and a different instance of the selected one of the concept, the relation, or the graph represents a second structure, and further wherein the first structure is similar to the second structure and no more specific in detail, the method further comprising subsuming the second structure by the first structure.

18. The method recited in claim 17, further comprising unifying the first structure and the second structure into a third structure if the subsuming step succeeds to provide discovery.

19. The method recited in claim 17, further comprising binding the first structure into the second structure to provide knowledge synthesis.

20. (canceled)

21. (canceled)

22. The method recited in claim 12, wherein the concept comprises a frame containing a graph that contains a single relation, and wherein the frame provides qualities of the concept and the relation.

23. A computer-readable medium having computer-executable instructions, which when executed perform a method for representing knowledge as a data structure, the instructions comprising: assigning certain information to a concept; representing a role that the concept plays in relation to other concepts using a relation; and representing the concepts and the relation using a graph.

24. The computer-readable medium recited in claim 23, wherein the concept, the relation, and the graph are represented in a graphical, linear, markup-based, or programmatic form.

25. The computer-readable medium recited in claim 23, wherein the relation has a type, the type is defined in the context of an ontology, and the ontology describes the relation type by indicating a number of arcs for the relation type, a label for each arc, and a type of a concept at the end of each arc.

26. The computer-readable medium recited in claim 23, further comprising using ontological support to create ontologies for specialized modalities to achieve extensibility.

27. The computer-readable medium recited in claim 23, wherein the graph can be expressed as a logical statement in the existential-conjunctive subset of first order logic.

28. The computer-readable medium recited in claim 27, wherein a selected one of the concept, the relation, or the graph represents a first structure and a different instance of the selected one of the concept, the relation, or the graph represents a second structure, and further wherein the first structure is similar to the second structure and no more specific in detail, the method further comprising subsuming the second structure by the first structure.

29. The computer-readable medium recited in claim 28, further comprising unifying the first structure and the second structure into a third structure if the subsuming step succeeds to provide discovery.

30. The computer-readable medium recited in claim 28, further comprising binding the first structure into the second structure to provide knowledge synthesis.

31. (canceled)

32. (canceled)

33. The computer-readable medium recited in claim 23, wherein the concept comprises a frame containing a graph that contains a single relation, and wherein the frame provides qualities of the concept and the relation.
